(19) United States
(12) Patent Application Publication
(10) Pub. No.: US 2014/0033508 A1
(43) Pub. Date: Feb. 6, 2014

(54) FIXING ELEMENT, FIXING SYSTEM, AND METHOD FOR SETTING THE FIXING ELEMENT

(71) Applicants: Willi Haug, Freudenstadt-Musbach (DE); Meinrad Zeh, Weitnau-Seltmans (DE); Thomas Former, Horb (DE); Berthold Weichert, Zimmern (DE)

(72) Inventors: Willi Haug, Freudenstadt-Musbach (DE); Meinrad Zeh, Weitnau-Seltmans (DE); Thomas Former, Horb (DE); Berthold Weichert, Zimmern (DE)

(73) Assignee: FISCHERWERKE GMBH & CO. KG, Waldachtal (JP)

(21) Appl. No.: 14/112,475

(22) PCT Filed: Apr. 24, 2012
(86) PCT No.: PCT/EP2012/001745

§ 371 Date: Oct. 17, 2013

(30) Foreign Application Priority Data
May 24, 2011 (DE) 10 2011 050 580.6

(51) Int. Cl. F16B 13/08

(52) U.S. Cl. CPC F16B 13/08
USPC 29/525.01; 411/108

(57) ABSTRACT

The invention relates to a fixing system (1) having a fixing element (2) and a setting device (18). The fixing element (2) has a shank (5) and an anchoring element (4). In order to provide a fixing system (1) which is simple and rapid to use, the invention proposes that the setting device (18) for driving in the anchoring element (4) be a pin driver device. The shank (5) of the fixing element has a receiving aperture (8) in which a through-hole (3) is arranged in such a way that the anchoring element (4) for anchoring the fixing element (2) can be introduced through the receiving aperture (8) and into the through-hole (3).

### TECHNICAL FIELD OF INVENTION

The invention relates to a fixing element having the features of the preamble of claim 1, to a fixing system having the features of the preamble of claim 6, and to a method, in accordance with claim 11, of setting a fixing element of the fixing system.

### DISCUSSION OF RELATED ART

From the Offenlegungsschrift DE 40 02 800 A1 there is known a fixing element for fixing a mountable part to an anchoring substrate. The fixing element is of pin-form construction, having a substantially cylindrical shank. Arranged on the shank is a fixing portion and a load attachment means in the form of a thread. Furthermore, there is provided in the shank, in the transition between the load attachment means and the fixing portion, a through-hole, which is inclined at an angle to the axis of the fixing element. For anchoring the fixing element in the anchoring substrate, a drilled hole is first produced in the anchoring substrate, and the fixing portion is introduced into the drilled hole. Then, through the through-hole, a further drilled hole is produced in the anchoring substrate, which further drilled hole is inclined with respect to the first drilled hole. In order to anchor the fixing element in the anchoring substrate, a cylindrical pin is introduced into the through-hole and the second drilled hole so that the cylindrical pin comes into abutment against the drilled hole wall of the through-hole and of the second drilled hole. As setting device there is used, for example, a hammer. The cylindrical pin brings about positive anchoring of the fixing element in the anchoring substrate. By virtue of the relatively large undercut area brought into action by the cylindrical pin in the anchoring substrate, the fixing element is very effective and achieves a high holding strength.

### SUMMARY OF THE INVENTION

The problem of the invention is to provide a fixing system which is simpler and faster to use.

The problem is solved in accordance with the invention by a fixing element, a fixing system and a method of setting the fixing element of the fixing system having the features of the independent claims.

The fixing element according to the invention has a shank and an anchoring element. Arranged on the shank is a fixing portion, by which the fixing element can be fixed in a drilled hole. The drilled hole is usually a blind hole which has been introduced into an anchoring substrate. Typically the anchoring substrate is made from concrete. “Fixing” in this context does not necessarily mean that the fixing element is fixed by the fixing portion in the drilled hole so that it can withstand traction and can no longer be pulled out of the drilled hole. The fixing portion located in the drilled hole serves mainly to take the forces acting in a transverse direction to the axis of the drilled hole. The fixing portion is, especially, cylindrical and has a solid cross-section in order to be able to take up even relatively large transverse forces. Also arranged on the shank of the fixing element is a load attachment means, by which the fixing element can be connected to a mountable part which is to be fixed to the anchoring substrate using the fixing element. The load attachment means is, for example, a thread. The shank also has a through-hole, the through-hole being inclined with respect to the axis of the shank. The “axis” means the longitudinal axis of the shank. The anchoring element can be introduced into that through-hole in order to anchor the fixing element in the anchoring substrate. In this context, “anchoring” means that the anchored fixing element can also take up tensile forces, that is to say forces which act parallel to the axis of the drilled hole. After anchoring, the fixing element is accordingly secured by the anchoring element against being pulled out of the drilled hole.

It is characteristic of the fixing element according to the invention that the shank has a receiving aperture in which the through-hole is arranged. The through-hole is so arranged that the anchoring element for anchoring the fixing element can be introduced through the receiving aperture and into the through-hole. The receiving aperture is arranged, especially, at the rear end of the shank and is substantially in the form of a hollow cylinder. “In the form of a hollow cylinder” here does not mean that the envelope surface has to be fully enclosed. The fixing element according to the invention allows setting using a pin driver device, further details of which will be given hereinbelow. This allows simple and rapid use.

In a preferred embodiment of the fixing element according to the invention, the load attachment means is arranged in the receiving aperture. The load attachment means is, especially, an internal thread. Preference is furthermore given to the through-hole being arranged substantially at the bottom of the receiving aperture so that the anchoring element does not interfere with use of the load attachment means. For example, when the through-hole is arranged at the bottom of the receiving aperture, an internal thread can be fully formed in the receiving aperture without the through-hole destroying some of the thread flanks of the internal thread or preventing them from being formed.

A further preferred embodiment of the fixing element according to the invention is characterised in that a ramp follows on from the through-hole in the driving-in direction of the anchoring element, which ramp is more markedly inclined with respect to the axis of the shank of the fixing element than the through-hole. When the anchoring element is driven into the through-hole, the ramp deflects the anchoring element radially outwards, as a result of which the front end of the anchoring element penetrates the anchoring substrate at a flatter angle and produces a larger undercut, which increases the holding strength.

The anchoring element is preferably a pin-driver nail, as is known, for example, from the publications DE 101 19 799 A1, EP 2 085 624 and WO 2010015349 A1. Pin-driver nails are characterised, especially, by their sturdy form, as a result of which they are very solid so that they can be driven into the anchoring substrate with great force.

The fixing system according to the invention comprises at least the fixing element according to the invention and a setting device for driving in the anchoring element. It is characteristic of the fixing system according to the invention that the setting device for driving in the anchoring element is a pin driver device. As a result of the use of the known pin driver technology, a fixing system is provided which allows the fixing element to be anchored in simple and time-saving manner. In order to introduce the anchoring element into the substrate, it is not necessary, as a result of the use of the pin driver technology, to pre-drill a second hole before the anchoring element is driven into the anchoring substrate. The system is a highly time-saving and effective system especially when the fixing system is used in an anchoring substrate of concrete. A pin driver is a fuel-driven setting device, as is known, for example, from the publications

EP 1 791 680 B1, DE 10 2006 000262 B3 or DE 197 55 407 B4. The known setting devices have a setting piston, which is guided in a guide tube of the setting device and which serves for driving in the anchoring element.

In a further preferred embodiment of the fixing system according to the invention, the diameter of the receiving aperture of the fixing element is larger than the diameter of the setting piston of the setting device. As a result, the setting piston can extend into the receiving aperture when the setting device is set upon the shank of the fixing element for driving in the anchoring element. “Diameter” refers to a circular cross-section. If the setting piston and/or the receiving aperture does not have a circular cross-section, the “diameter of the setting piston” means the diameter of a circle circumscribing the cross-section of the setting piston and the “diameter of the receiving aperture” means the diameter of an incircle.

Preference is furthermore given to the setting piston, after driving the anchoring element into the anchoring substrate, projecting an outward travel distance beyond the guide tube of the setting device. The outward travel distance corresponds preferably to the depth of the receiving aperture so that that end of the setting piston which is to the front in the driving-in direction remains in contact with that end of the pin-driver nail which is to the rear in the driving-in direction throughout the driving-in process. Accordingly, force transfer from the setting piston to the anchoring element is ensured over the entire driving-in path.

Preference is furthermore given to the direction of movement of the setting piston during driving-in of the anchoring element being inclined with respect to the direction of movement of the anchoring element. This embodiment simplifies use of the fixing system as the anchoring element can consequently be mounted, for example, in the pin driver device and introduced into the drilled hole in that manner and the anchoring element can be driven in in that orientation without its being necessary to pivot or turn the pin driver device.

For setting of the fixing element of the fixing system according to the invention, there is first of all produced a drilled hole for receiving the fixing portion of the fixing element in the anchoring substrate. A “drilled hole” here means in general terms an opening for receiving the fixing element. The drilled hole is typically made in the form of a blind drilled hole. However, it can also be made, for example, in the form of an undercut hole or a through-hole, and preferably also as a stepped hole. The fixing element with the fixing portion is introduced into the drilled hole, and the anchoring element is pushed into the through-hole with its being possible for this to be carried out before or after introduction of the fixing portion into the drilled hole. After placing the pin driver device in position, the anchoring element is driven into the anchoring substrate without prior pre-drilling of a further drill hole in the anchoring substrate for receiving the anchoring element. Placing of the nail driver device in position is so carried out that a setting piston of the pin driver device can penetrate into a receiving aperture of the shank in order to drive the anchoring element into the anchoring substrate. The fixing element can be mounted on the setting device before introduction into the drilled hole so that placing of the pin driver device in position is carried out even before introducing the fixing portion into the drilled hole.

The invention is explained hereinbelow in greater detail with reference to an exemplary embodiment shown in the drawings, in which:

### BRIEF DESCRIPTION OF THE DRAWINGS

FIGS. 1 and 2 show a fixing element according to the invention in perspective views;

FIG. 3 shows a fixing system according to the invention before the anchoring element is driven into an anchoring substrate; and

FIG. 4 shows the fixing system according to the invention after the anchoring element has been driven into the anchoring substrate.

### DETAILED DESCRIPTION OF THE INVENTION

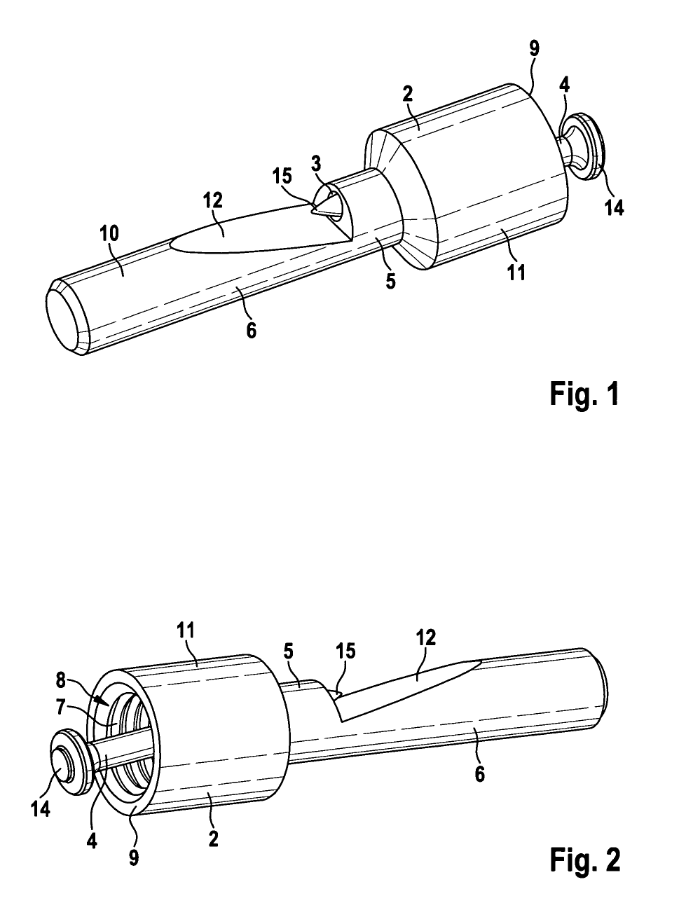

FIGS. 1 and 2 show a fixing element 2 of a fixing system according to the invention, having a through-hole 3, into which an anchoring element 4 has been introduced. Besides the anchoring element 4, the fixing element 2 has a shank 5 provided with a fixing portion 6, with a load attachment means 7 and with the through-hole 3. The fixing portion 6 serves for fixing the fixing element 2 in a drilled hole. The load attachment means 7 is in the form of an internal thread, which is arranged in a receiving aperture 8 at that end 9 of the fixing element 2 which is to the rear in the direction of introduction. The shank 5 consists of two cylindrical basic bodies 10, 11, the first cylindrical basic body 10 forming the fixing portion 6. The first cylindrical basic body 10 is arranged forward of the second cylindrical body 11 in the direction of introduction and has a smaller diameter than the second cylindrical basic body 11. The first cylindrical basic body 10 is of solid construction, having a wedge-shaped ramp 12, where the exit aperture 13 of the through-hole 3 opens out. The second cylindrical basic body 11 is in the form of a hollow cylinder which is open to the rear and which forms the receiving aperture 8 having the load attachment means 7. The anchoring element 4 is a sturdy pin-driver nail, having a head 14 and a tip 15.

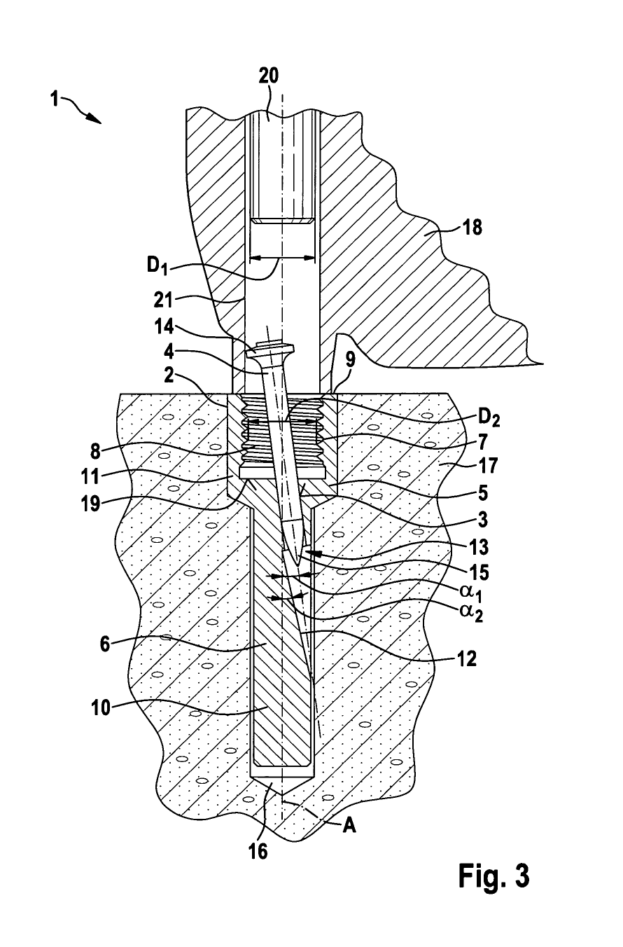

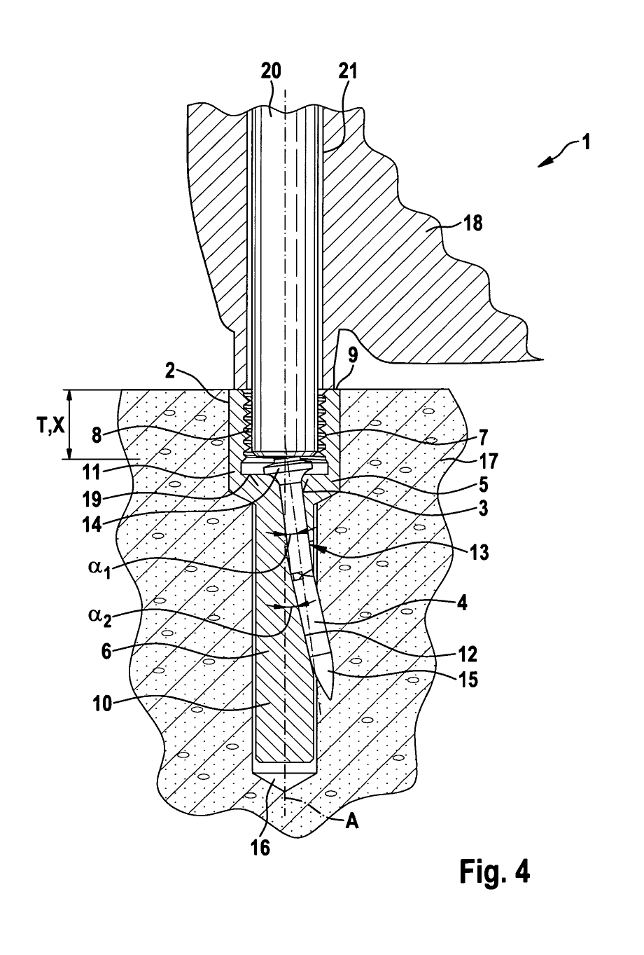

For setting the fixing element 2, first of all, as shown in FIGS. 3 and 4, a drilled hole 16 for receiving the fixing element 2 of the fixing system 1 is produced in an anchoring substrate 17. The drilled hole 16 is a stepped hole whose forward cylindrical portion of small diameter receives the fixing portion 6 of the fixing element 2, whereas the second cylindrical basic body 11 is received by the rear region of the stepped hole. In order to secure the fixing element 2 from being pulled out from the drilled hole 16, the anchoring element 4 must be driven into the anchoring substrate 17. Driving-in is carried out by means of a setting device 18, a pin driver device, by means of which the anchoring element 4, that is to say the pin-driver nail, is driven into the anchoring substrate 17 without further pre-drilling. For that purpose, the anchoring element 4 is first of all introduced into the through-hole 3, which can be carried out before or after insertion of the fixing element 2 into the drilled hole 16. The through-hole 3 is arranged at the bottom 19 of the receiving aperture 8 and is inclined with respect to the axis A of the shank 5 by the angle α₁.

The pin driver device used as setting device 18 has a setting piston 20, which is guided in a guide tube 21 of the setting device 18. The diameter D₁ of the setting piston 20 is so selected that the diameter D₂ of the receiving aperture 8 is larger than the diameter D₁ of the setting piston 20. The setting device 18 is set upon the shank 5 of the fixing element 2 and fired so that the setting piston 20 is moved forwards in order to drive in the anchoring element 4; it hits the head 14 of the anchoring element 4, moves the latter further forwards and, in the process, extends into the receiving aperture 8, the direction of movement of the setting piston 20 on driving in the anchoring element 4 being inclined with respect to the direction of movement of the anchoring element 4. The setting piston 20 drives the anchoring element 4 further into the through-hole 3 so that the tip 15 of the anchoring element 4 hits the ramp 12. The wedge-shaped ramp 12 is inclined, with respect to the longitudinal axis A, by an angle α₂, which is larger than the angle of inclination α₁ of the through-hole 3, as a result of which the tip 15 of the anchoring element 4 is deflected radially outwards. The tip 15 of the anchoring element 4 enters the anchoring substrate 17, without a further drilled hole having had to be produced in the anchoring substrate 17 in order to receive the anchoring element 4.

The setting process is complete when the head 14 of the anchoring element 4 comes into abutment against the bottom 19 of the receiving aperture 8. In this arrangement, the outward travel distance X of the setting piston 20, that is to say the distance that the setting piston 20 projects out from the guide tube 21, corresponds to the depth T of the receiving aperture 8. In this case, this means that the outward travel distance X and the height of the head 14 is equal to the depth T of the receiving aperture 8. When the head 14 comes into abutment against the bottom 19 of the receiving aperture 8, the setting process is complete, and the setting device 18 can be removed from the fixing element 2. Because the anchoring element 4 has been introduced completely into the receiving aperture 8, the load attachment means 7, the internal thread, is freely accessible so that a mountable part (not shown) can be fixed to the fixing element 2 using a screw.

Using the fixing system 1 shown in FIGS. 1 to 4, speedy and effective anchoring of the fixing element 2 in an anchoring substrate 17 is possible.

### List of Reference Numerals and Letters

1 fixing system
2 fixing element
3 through-hole
4 anchoring element
5 shank
6 fixing portion
7 load attachment means
8 receiving aperture
9 rear end of fixing element 2
10 first cylindrical basic body
11 second cylindrical basic body
12 ramp
13 exit aperture of through-hole 3
14 head of anchoring element 4
15 tip of anchoring element 4
16 drilled hole
17 anchoring substrate
18 setting device
19 bottom of receiving aperture 8
20 setting piston
21 guide tube
22 pin-driver nail
D₁ diameter of setting piston 20
D₂ diameter of receiving aperture 8
A axis of shank 5
X outward travel distance
T depth of receiving aperture 8
α₁ angle between axis A of shank 5 and through-hole 3
α₂ angle between ramp 12 and through-hole 3

1. The fixing element having a shank and an anchoring element (4), there being arranged on the shank a fixing portion for fixing the fixing element in a drilled hole in an anchoring substrate, a load attachment means for connecting the fixing element to a mountable part, and a through-hole, the through-hole being inclined with respect to the axis (A) of the shank, and into which through-hole the anchoring element is arranged to be introduced for anchoring the fixing element in the anchoring substrate, wherein
the shank has a receiving aperture in which the through-hole is arranged in such a way that the anchoring element for anchoring the fixing element can be introduced through the receiving aperture and into the through-hole.

2. The fixing element according to claim 1, wherein the load attachment means is an internal thread arranged in the receiving aperture.

3. The fixing element according to claim 1, wherein the through-hole is arranged substantially at the bottom of the receiving aperture.

4. The fixing g element according to claim 1, wherein a ramp follows on from the through-hole in the driving-in direction of the anchoring element, which ramp is more markedly inclined with respect to the axis (A) of the shank than the through-hole.

5. The fixing element according to claim 1, wherein the anchoring element is a pin-driver nail.

6. The fixing system having a fixing element according to claim 1 and a setting device for driving in the anchoring element,
wherein
the setting device is a pin driver device having a setting piston for driving in the anchoring element, which setting piston is guided in a guide tube of the setting device.

7. The fixing system according to claim 6, wherein the diameter (D₂) of the receiving aperture of the fixing element is larger than the diameter (D₁) of the setting piston so that, for driving in the anchoring element, the setting device is arranged to be set upon the shank of the fixing element in such a way that the setting piston can extend into the receiving aperture.

8. The fixing system according to claim 6, wherein the setting piston, after driving in the anchoring element, projects an outward travel distance (X) beyond the guide tube of the setting device.

9. The fixing system according to claim 8, wherein the outward travel distance (X) corresponds to the depth (T) of the receiving aperture.

10. The fixing system according to claim 9, wherein the direction of movement of the setting piston during driving-in of the anchoring element is inclined with respect to the direction of movement of the anchoring element.

11. The method of setting a fixing element of a fixing system according to claim 6, comprising the following steps:
a) producing a drilled hole for receiving the fixing portion in an anchoring substrate;
b) introducing the fixing portion into the drilled hole;
c) introducing the anchoring element into the through-hole;
d) placing the setting device in position in such a way that a setting piston of the setting device can extend into a receiving aperture of the shank for driving the anchoring element into the anchoring substrate; and
e) driving the anchoring element into the anchoring substrate without prior pre-drilling of a further drilled hole in the anchoring substrate for receiving the anchoring element.

12. The method according to claim 11, wherein step c) is carried out before step b).

13. The method according to claim 11, wherein the drilled hole is a stepped hole.
